(19) United States
(12) Patent Application Publication
(10) Pub. No.: US 2003/0206202 A1
(43) Pub. Date: Nov. 6, 2003

(54) Information processing apparatus

(76) Inventor: Takashiro Moriya, Tokyo (JP)

Correspondence Address: MICHAEL BEST & FRIEDRICH LLC, 401 NORTH MICHIGAN AVENUE, SUITE 1700, CHICAGO, IL, 60611-4212, US

(21) Appl. No.: 10/427,478

(22) Filed: May 1, 2003

(30) Foreign Application Priority Data
May 2, 2002 (JP) 130660/2002

(51) Int. Cl. G09G 5/00

(52) U.S. Cl. 345/846

(57) ABSTRACT

To provide an information processing apparatus which does not block miniaturization, weight saving and low-profile making and prevents a malfunction. It has a contact detection portion for detecting contact with an icon displayed in a touch panel portion, a slide detection portion for detecting a slide of the touch panel portion against an information processing apparatus body, and an execution portion for, in the case where the slide detection portion detects the slide of the touch panel portion 3 in a state in which the contact detection portion is detecting the contact with the icon, starting an application program and opening a file corresponding to the icon.

### BACKGROUND OF THE INVENTION

1. Field of the Invention

The present invention relates to an information processing apparatus, and in particular, to the information processing apparatuses such as a portable telephone and a PDA (Personal Digital Assistant).

2. Description of the Prior Art

An information input apparatus in the past using a touch panel such as a portable telephone or a PDA can, as its greatest characteristic, display only necessary information on a liquid crystal display panel when necessary and thereby provide a simple and easy operating portion such as a button.

Incidentally, there are the cases where a malfunction occurs due to an unintended operation. In particular, in the case of the portable telephone, there are the cases where a transmission button is pushed by mistake while carrying it in a bag.

Here, Japanese Patent Laid-Open No. 2001-69223 discloses a technology for rendering a scroll operation easily and securely performable in vertical and horizontal directions respectively to prevent the malfunction.

According to the above patent laid-open, the portable telephone has an X-axis direction scroll operating portion for performing the scroll operation in the horizontal direction (X-axis direction) of a display screen and a Y-axis direction scroll operating portion for performing the scroll operation in the vertical direction (Y-axis direction) of the display screen in a lower part and a left side part of a display portion respectively. It describes that these operating portions are constituted to have a touch pad in long and thin shape so as to allow an instruction of the scroll operation independently in each direction.

In addition, Japanese Patent Laid-Open No. 2001-273080 discloses a technology to be applied to a portable information terminal apparatus, for example, for the sake of constituting it to accept various inputs by operating an operation element so as to divert it simply to various apparatuses.

According to the above patent laid-open, it is described that the operation of the operation element on a control panel is detected by the touch panel placed on an image display panel, and a processing program involved in this detection process is replaceable together with the control panel.

However, the technologies in the past perform the scroll operation and accept various inputs by operating the operation element, and so there are the cases where they block miniaturization, weight saving and low-profile making required of the portable information terminal such as the portable telephone or PDA.

Thus, an object of the present invention is to provide the information processing apparatus which does not block the miniaturization, weight saving and low-profile making and prevents the malfunction.

### BRIEF SUMMARY OF THE INVENTION

To solve the above problem, the present invention is characterized by having a display portion for displaying an icon and slidable against an information processing apparatus proper, a contact detection portion for detecting contact with said icon displayed in said display portion, a slide detection portion for detecting a slide of said display portion against the information processing apparatus proper, and an execution portion for, in the case where said slide detection portion detects the slide of said display portion in a state in which said contact detection portion is detecting contact with said icon, starting an application of the icon and opening a file.

### BRIEF DESCRIPTION OF THE DRAWINGS

FIG. 1 is a schematic perspective view of an information input apparatus according to a first embodiment of the present invention;

FIG. 2 is a schematic exploded perspective view of the information input apparatus according to FIG. 1;

FIG. 3 are sectional views between A-A and between B-B in FIG. 2;

FIG. 4 is a block diagram showing a schematic internal configuration of the information processing apparatus shown in FIG. 1;

FIG. 5 is a flowchart showing an operation of the information processing apparatus shown in FIG. 1;

FIG. 6 is a diagram for explaining operating situation of a touch panel portion 3 of the information processing apparatus shown in FIG. 1;

FIG. 7 is a diagram showing sizes of the touch panel portion 3 and information processing apparatus proper 5 related to a second embodiment of the present invention; and

FIG. 8 is a diagram showing the sizes of the touch panel portion 3 and information processing apparatus body 5 related to the second embodiment of the present invention.

### DETAILED DESCRIPTION OF THE PREFERRED EMBODIMENTS

Hereafter, embodiments of the present invention will be described by referring to the drawings.

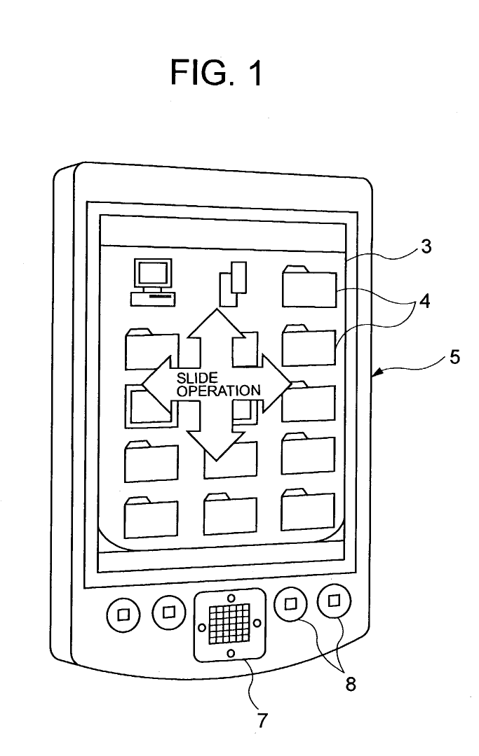

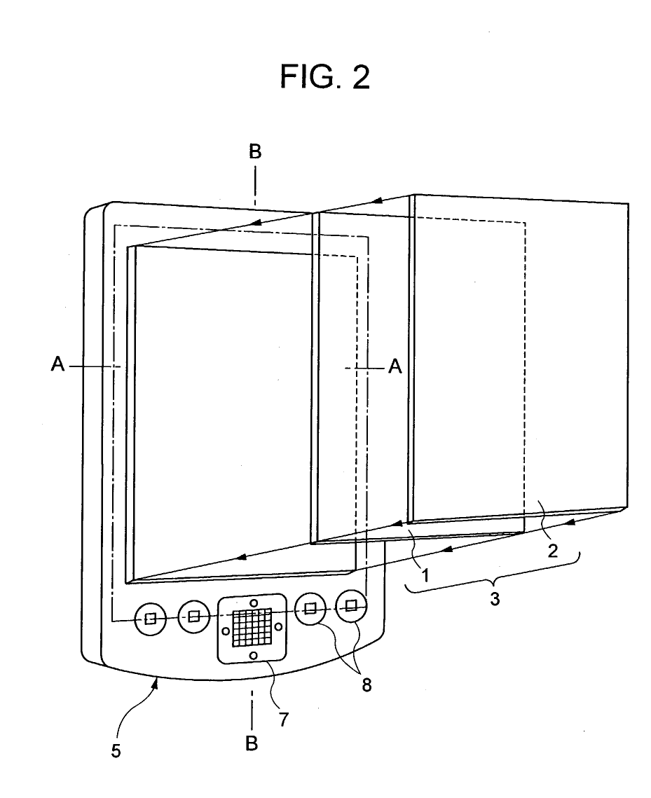

FIG. 1 is a schematic perspective view of an information input apparatus according to a first embodiment of the present invention. FIG. 2 is a schematic exploded perspective view of the information input apparatus according to FIG. 1.

The information processing apparatus shown in FIGS. 1 and 2 has an information processing apparatus body 5 and a touch panel portion 3 comprised of a display 1 for displaying an icon 4 and a touch panel 2 including a piezoelectric element.

Its essential operation is to slide the touch panel portion 3 against the information processing apparatus body 5 in horizontal and vertical directions when starting an application program and opening a file corresponding to the icon 4 displayed on the display 1.

In addition, an operation key 8 of a power supply and so on of the apparatus and a speaker 7 are provided on the downside of the touch panel portion 3.

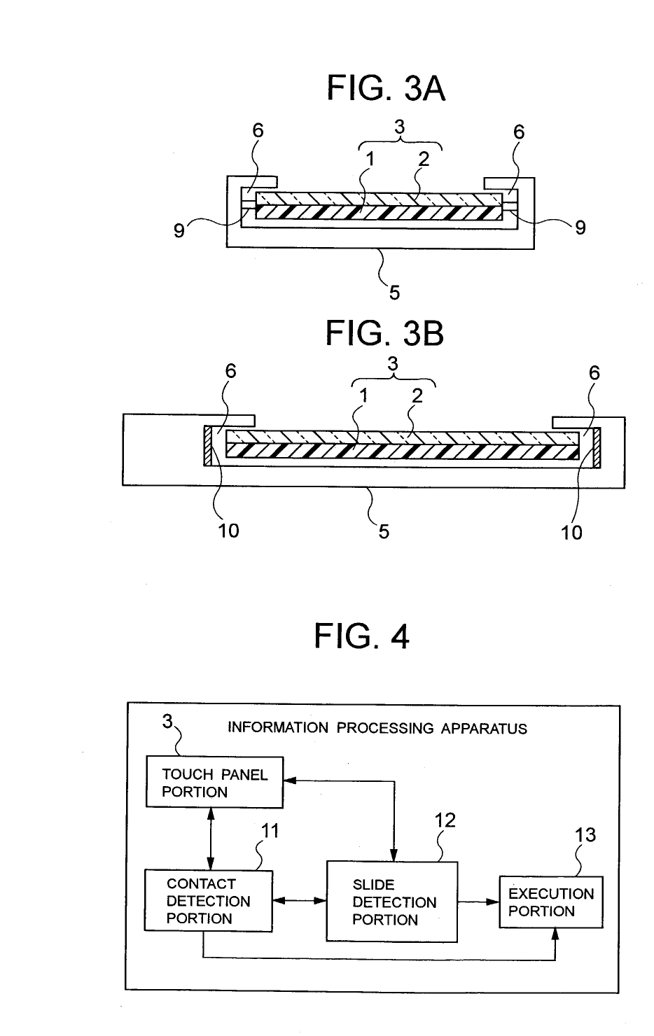

FIG. 3A is a sectional view between A-A in FIG. 2. FIG. 3B is a sectional view between B-B in FIG. 2.

As shown in FIGS. 3A and 3B, a space 6 is provided to render the touch panel portion 3 slidable against the information processing apparatus body 5. The touch panel portion 3 is connected to the information processing apparatus body 5 by an elastic body 9 such as a spring or rubber in order to return the slid touch panel portion 3 to its original position. In the case where no power for sliding is applied to the touch panel portion 3, the touch panel portion 3 keeps a central position.

While an example having the elastic body 9 provided on a side face of the touch panel portion 3 is shown here, the elastic body 9 may be provided on a rear face of the touch panel portion 3.

Moreover, for instance, a piezoelectric element 10 for outputting an electrical signal on contacting the side face of the slid touch panel portion 3 is provided on an inner wall of the information processing apparatus body 5. The piezoelectric element 10 may also be provided on the touch panel portion 3.

Furthermore, it is also possible to provide various sensors such as a light sensor and a magnetometric sensor, instead of the piezoelectric element 10, for detecting a relative slide distance between the touch panel portion 3 and the information processing apparatus body 5.

FIG. 4 is a block diagram showing a schematic internal configuration of the information processing apparatus shown in FIG. 1. FIG. 4 shows a contact detection portion 11 for detecting contact with the icon 4 displayed in the touch panel portion 3, a slide detection portion 12 for detecting a slide of the touch panel portion 3 against the information processing apparatus body 5, and an execution portion 13 for, in the case where the slide detection portion 12 detects the slide of the touch panel portion 3 in a state in which the contact detection portion 11 is detecting the contact with the icon 4, starting an application program and opening a file corresponding to the icon 4.

Moreover, the contact detection portion 11 includes the piezoelectric element of the touch panel 2, and the slide detection portion 12 includes the piezoelectric element 10.

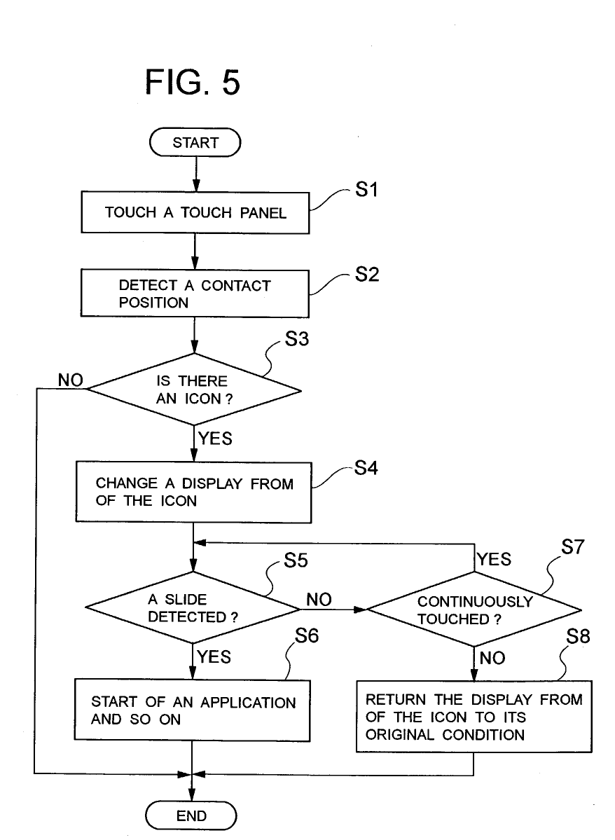

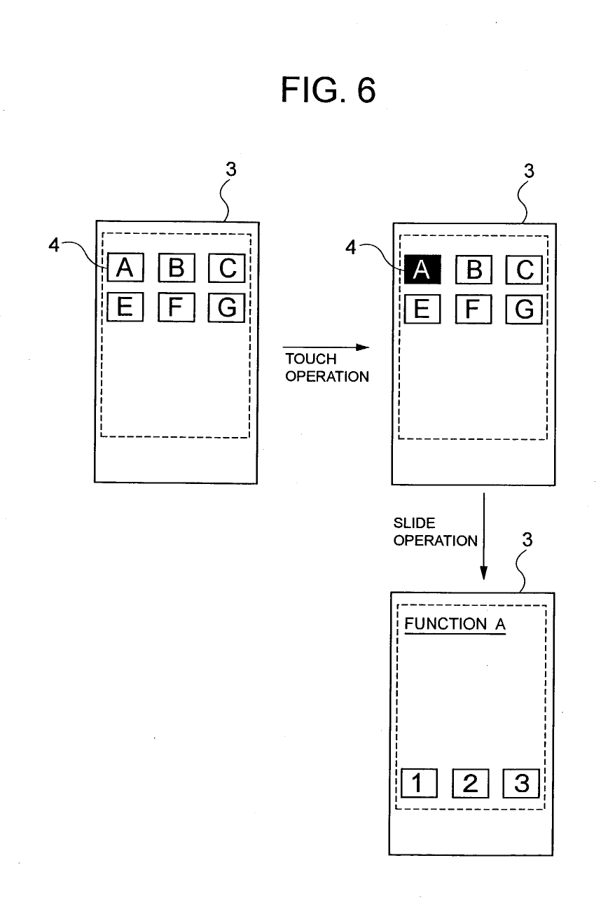

FIG. 5 is a flowchart showing the operation of the information processing apparatus shown in FIG. 1. FIG. 6 is a diagram for explaining operating situation of the touch panel portion 3 of the information processing apparatus shown in FIG. 1.

First, as shown in FIG. 1, if a user touches the touch panel 2 in a state of having the icon 4 displayed on the display 1 (step S1), the contact is detected and a contact position is further detected by the contact detection portion 11 (step S2).

Next, it is determined whether or not there is the icon 4 at the position detected by the contact detection portion 11 (step S3). As a result of the determination, a process shown in FIG. 4 is finished if there is no icon 4 at the position detected by the contact detection portion 11.

As a result of the determination, if there is the icon 4 at the position detected by the contact detection portion 11, the user is notified, by changing the display of the icon 4 as shown in FIG. 6 for instance, that the icon 4 was touched (step S4).

Next, if the touch panel portion 3 is slid against the information processing apparatus body 5 in a state in which the user is touching the icon 4, which is detected by the slide detection portion 12 (step S5), the execution portion 13 starts the application program and opens the file corresponding to the icon 4 as shown in FIG. 6 (step S6).

In the case where the slide of the touch panel portion 3 against the information processing apparatus body 5 is not detected by the slide detection portion 12, it is determined whether or not the icon 4 is continuously touched (step S7).

As a result of the determination, in the case where the icon 4 is continuously touched, it returns to the step S6. In the case where the icon 4 is not continuously touched, the form of the display of the icon 4 is returned to its original condition (step S8) so as to finish the process shown in FIG. 4.

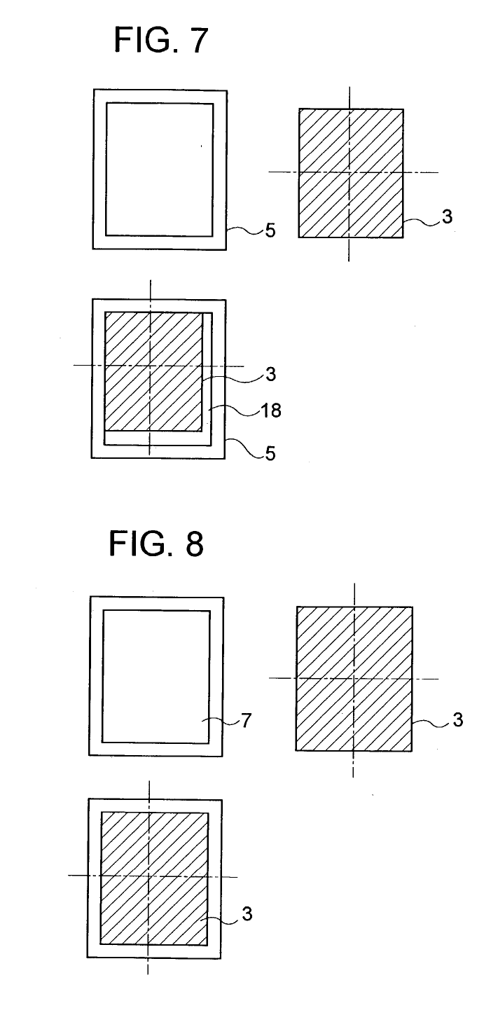

FIGS. 7 and 8 are diagrams showing sizes of the touch panel portion 3 and information processing apparatus body 5 related to a second embodiment of the present invention. If the touch panel portion 3 is slid against the information processing apparatus body 5, a dead space 18 arises as shown in FIG. 7, and a part of the touch panel portion 3 becomes invisible to the user on the information processing apparatus body 5.

Thus, as shown in FIG. 8, it is possible, as for the touch panel portion 3, to change the displayable area of the icon 4 and so on based on the slide distance of the touch panel portion 3.

To be more specific, the slide detection portion 12 can detect the relative slide distance between the touch panel portion 3 and information processing apparatus body 5, and there is an image processing portion provided for software-wise displacing the displayable area of the icon 4 and so on in the touch panel portion 3, for instance, based on the detection results.

As described above, according to the present invention, it is possible to provide the information processing apparatus which does not block the miniaturization, weight saving and low-profile making and prevents the malfunction.

What is claimed is:

1. An information processing apparatus wherein:
a display portion for displaying an icon and slidable against an information processing apparatus body;
a contact detection portion for detecting contact with said icon displayed in said display portion;
a slide detection portion for detecting a slide of said display portion against the information processing apparatus body; and
an execution portion for, in the case where said slide detection portion detects the slide of said display portion in a state in which said contact detection portion is detecting contact with said icon, starting an application program and opening a file corresponding to the icon are provided.

2. The information processing apparatus according to claim 1, wherein said display portion is constituted to be slidable by being connected to said information processing apparatus body with at least one elastic body.

3. The information processing apparatus according to claim 2, wherein said elastic body is connected to a rear face or a side face of said display portion.

4. The information processing apparatus according to claim 1, wherein each of said detection portions has a piezoelectric element and performs detection from the piezoelectric element according to an electrical signal.

5. The information processing apparatus according to claim 1, wherein said slide detection portion detects the slide based on a relative slide distance between said display portion and said information processing apparatus body.

6. The information processing apparatus according to claim 5, wherein an image processing portion for displacing a displayable area of said display portion in an opposite direction to a slide direction of said display portion based on detection results of said slide detection portion is provided.
